(19) United States
(12) Patent Application Publication
(10) Pub. No.: US 2004/0244529 A1
(43) Pub. Date: Dec. 9, 2004

(54) Workpiece, in particular a crankshaft

(76) Inventor: Georg Toplack, (US)

Correspondence Address: Mark D. Lorusso, Lorusso, Loud & Kelly LLP, 15 Rye Street, Portsmouth, NH, 03801, US

(21) Appl. No.: 10/861,023

(22) Filed: Jun. 4, 2004

(30) Foreign Application Priority Data
Jun. 4, 2003 (AT) A 865/2003

(51) Int. Cl. F16C 3/04

(52) U.S. Cl. 74/595

(57) ABSTRACT

A workpiece, in particular a crankshaft, the surface of which in a region (4, 4′) to be hardened has a plurality of mutually spaced, hardened, preferably laser-hardened portions, characterised in that the extent (d) and/or the spacing (s) of the hardened, preferably substantially punctiform portions vary (varies) over the region (4, 4′) to be hardened.

The present invention concerns a workpiece, in particular a crankshaft, the surface of which in a region to be hardened has a plurality of mutually spaced, hardened, preferably laser-hardened portions.

Workpieces and in particular crankshafts which represent the very heart of any reciprocating-piston machine are highly loaded parts and therefore must be of a durable design. The cranked configuration of crankshafts means that a very irregular flow of forces occurs so that high stress loadings arise in particular in the transitional radii between the journals and the side cheeks. In order to increase the long-term alternate-stress strength, some processes are already known in accordance with the state of the art, which introduce a compression prestressing into the surface layer. The processes which are already known include for example high-frequency hardening, nitriding, rolling, hammering and also the combination of hardening and hammering.

The state of the art also includes for example German laid-open application DE 101 26 165 A1 in which, to harden a surface region of a workpiece, punctiform portions of the surface region are successively produced by means of a pulsed laser beam. The point arrangement of the hardness points in a matrix causes the production of compression stress centers, wherein relatively tough ductile material in the initial state is always disposed between the individual points. In the state of the art the hardness points are applied in an equidistant pattern.

Therefore the object of the present invention is to provide an improved workpiece having a higher level of long-term alternate-stress strength.

In accordance with the invention that is achieved in that the extent and/or the spacing of the hardened, preferably substantially punctiform portions vary (varies) over the region to be hardened.

In other words the hardness points are irregularly distributed. That permits a gentle variation without abrupt limits in respect of the region to be hardened. In tests it has been found that this concept provides that cracks which possibly develop at the hardened portions are stopped in the surrounding unhardened material and thus the long-term alternate-stress strength is improved. The arrangement, size and depth of the hardness points can be controlledly established by the laser parameters, in particular focus, power and pulse duration.

Further advantages of the invention lie in the short passage time of the workpieces to be treated so that the energy consumption or the development of heat is reduced. In addition, no grinding process is required after the hardening operation, while furthermore any distortion phenomena which may be present (deviations from axis parallelism) can be corrected with the system.

The fact that the density defined as the ratio of the extent of a hardened portion relative to the spacing of the most closely adjacent portion, identified as d/s, for at least a part of the region to be hardened and preferably for substantially all hardened portions, decreases towards the edge of the region to be hardened, permits on the one hand a gentle boundary configuration in respect of the hardened region, while on the other hand that ensures that a smaller amount of heat is developed, whereby deformation and power consumption can be minimised. That is also achieved by the extent (d) of the hardened portions decreasing towards the edge.

The fact that the edge of the region to be hardened, in a flat development, is of a substantially polygonal or elliptical configuration, provides that the compression stresses are distributed uniformly starting from the center point of the hardness region.

The fact that the hardened portions are arranged at least partially and preferably substantially exclusively in the rounded-off transitional region means that it is possible to implement local hardening of that zone where the compression stresses are at the greatest.

It is desirable if the hardened portions are arranged at least partially and preferably substantially exclusively in the rounded-off transitional region, in which respect it is sufficient if a hardening operation is effected only within an angle sector α facing towards the side cheek.

In accordance with a further embodiment a load-relief notch is arranged partially in the region of the rounded-off transition and partially in the crank pin and/or a notch is arranged partially in the region of the rounded-off transition and partially in the shaft journal. The arrangement of the notch provides for an efficient reduction in the stress concentrations which occur between the crank pin and the crank cheek and between the shaft journal and the crank cheek. The crankshaft can thus be of smaller dimensions, even when higher levels of power are involved, without further strength-increasing measures being required for that purpose. That is particularly desirable in relation to large internal combustion engines such as for example stationary gas engines for driving generators and the like. The measure of the load-relief notch can advantageously be combined with the idea of the laser points by the latter extending at least in a region-wise manner into the load-relief notch.

Further details and features of the present invention will be apparent from the specific description hereinafter. In the drawing:

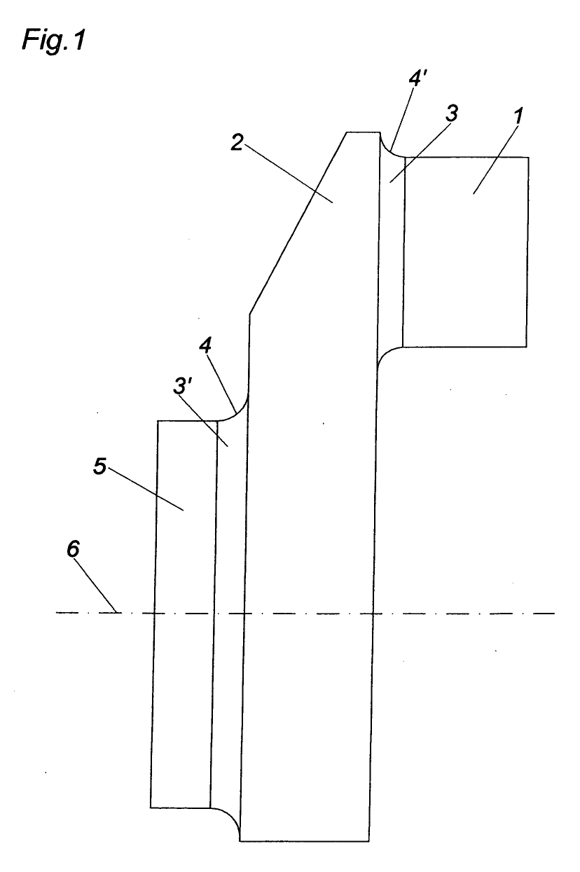

FIG. 1 is a diagrammatic side view of a part of a crankshaft,

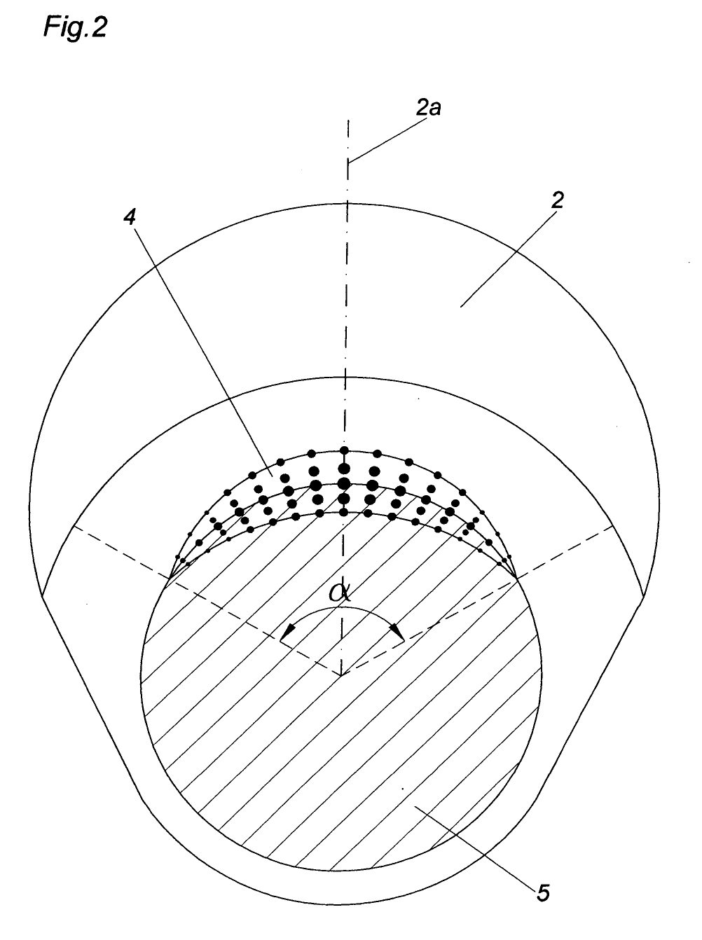

FIG. 2 is a diagrammatic front view of the crankshaft,

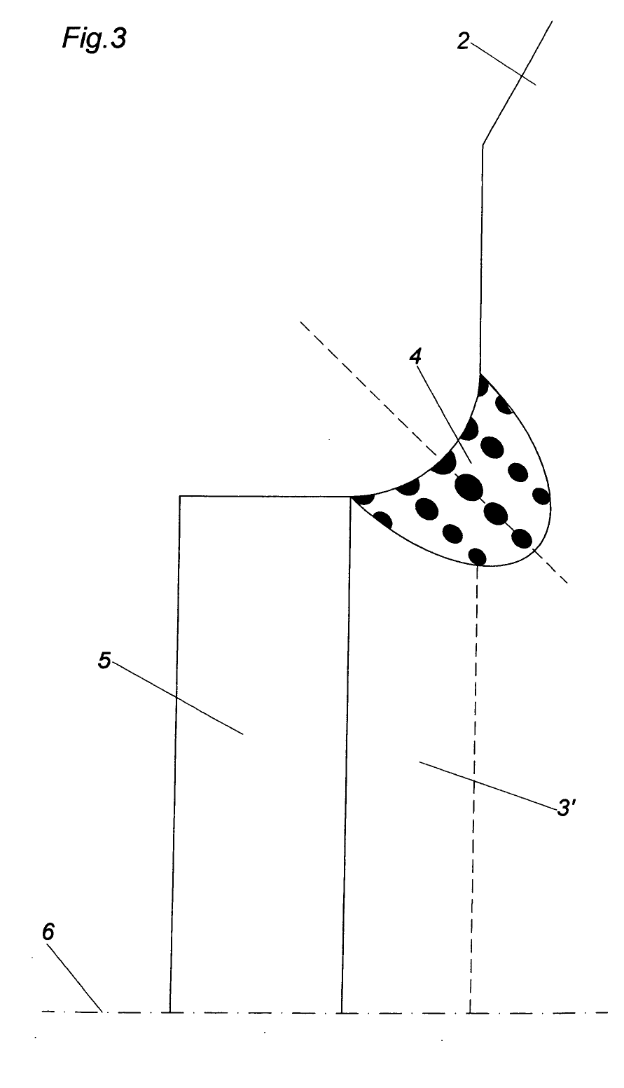

FIG. 3 is a detail side view on an enlarged scale of the crankshaft,

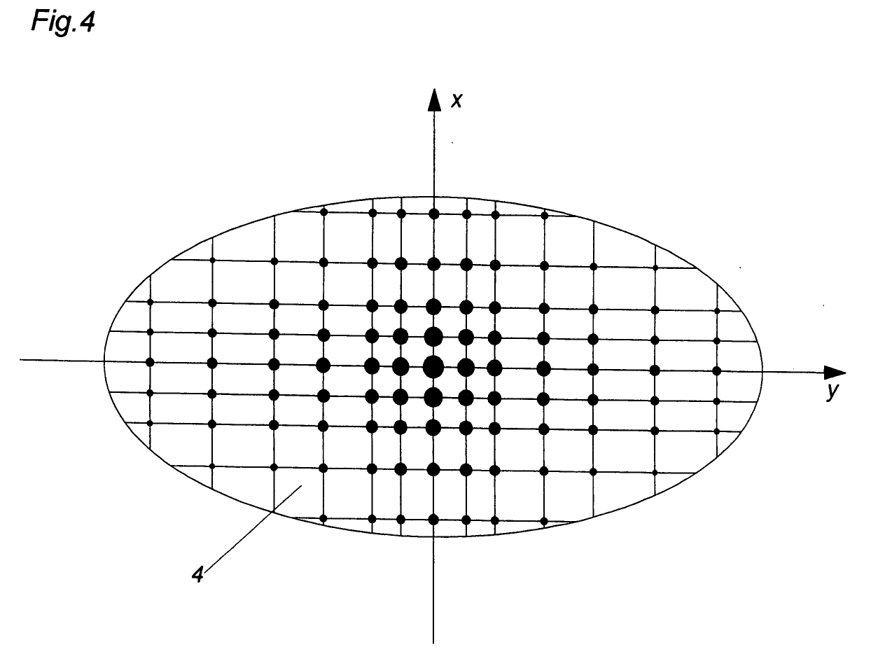

FIG. 4 is a diagrammatic view of the hardened region,

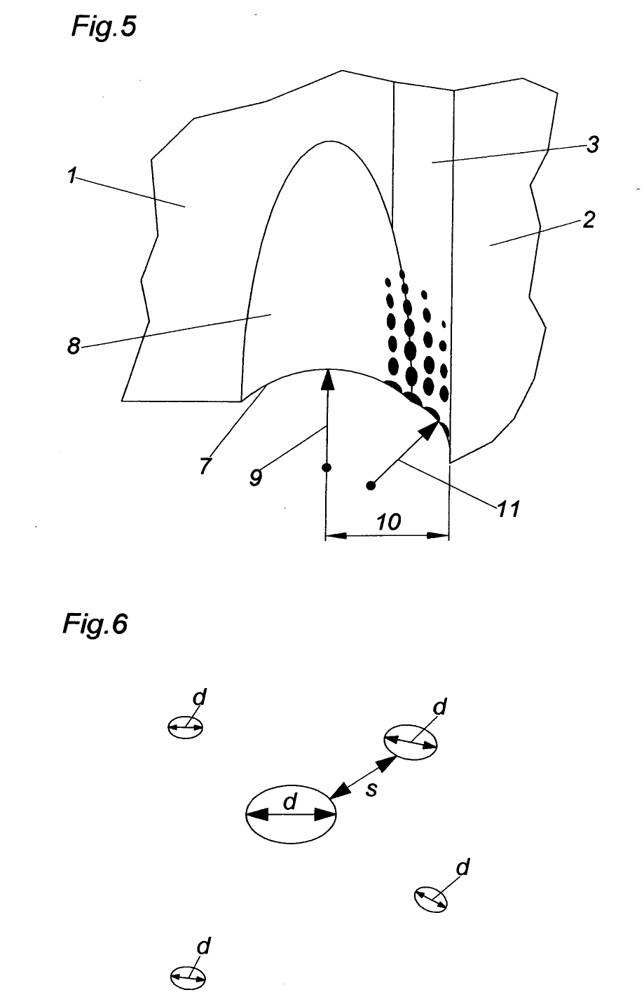

FIG. 5 is a diagrammatic view of an optional load-relief notch, and

FIG. 6 shows a diagrammatic arrangement of the hardness points for the deformation of the spacing s and the extent d.

FIG. 1 shows a portion of a crankshaft with a crank pin 1, a crank side cheek 2 and a shaft journal 5 with a notional axis of rotation 6. A rounded-off transition 3 is provided between the crank pin 1 and the crank side cheek 2. In a corresponding fashion a rounded-off transition 3′ is to be found between the shaft journal 5 and the crank side cheek 2. The hardened regions 4 and 4′ respectively are disposed in a region of the rounded-off transition 3 and 3′ respectively. The base material comprises a hardenable steel.

FIG. 2 shows a front view of the crankshaft with a shaft journal 5, a crank side cheek 2 and a hardened region 4. The angle sector α is disposed symmetrically with respect to the axis 2a of the side cheek 2. Hardening is effected only within the angle sector α facing towards the side cheek 2. The angle sector α is in a range of between 30° and 150°, preferably in a range of between 60° and 120°.

FIG. 3 shows a view on an enlarged scale of the side view of FIG. 1 with a crank side cheek 2, a shaft journal 5 with a notional axis of rotation 6 of the crankshaft. The hardened portion 4 is arranged at least partially and preferably substantially exclusively in the rounded-off transitional region 3′.

FIG. 4 shows a diagrammatic arrangement of the hardness points in a hardened region 4. In a flat development, the edge of the region to be hardened is of a substantially polygonal or elliptical configuration. The density d/s defined as the ratio of the extent d of a hardened portion to the spacing s of the most closely adjacent portion, for at least a part of the region to be hardened, preferably for substantially all hardened portions, is between 0.1 mm and 0.5 mm, preferably between 0.5 mm and 2.0 mm. The density d/s defined as the ratio of the extent d of a hardened portion to the spacing s of the most closely adjacent portion, for at least a part of the region to be hardened, preferably for substantially all hardened portions, in the center of the region to be hardened, is between 1.0 mm and 7 mm, preferably being 5.0 mm, and continuously decreases outwardly to a value of 0.05 mm to 3.0 mm, preferably 0.1 mm.

FIG. 5 shows a view in the region of the optional notch 8 which is arranged partially in the region of the rounded-off transition 3 and partially in the crank pin 1 and/or a notch 8 partially in the region of the rounded-off transition 3′ and partially in the shaft journal 5. The notch 8 is arranged in the crank pin 1 on the side which faces towards the notional axis of rotation 6 of the crankshaft (inwardly). The notch 8 is preferably substantially in the shape of a segment of an arc 7 in a notional section through the crank side cheek 2 and the crank pin 1, preferably in the region of the greatest depth of the notch 8. The radius 9 of the arcuate segment 7 is desirably greater than the radius 11 of the rounded-off transition 3. The distance 10 of the center point of the arcuate segment 7 from the crank side cheek 2 is desirably smaller than or equal to the sum of the radius 11 of the rounded-off transition 3 and half the radius 9 of the arcuate segment 7. By virtue of the arrangement of the notch 8, such as to partially cover the rounded-off transition 3 and/or 3′, the notch 8 is disposed sufficiently closely to the critical transition radius so that the surface area is locally increased thereby and stretching phenomena can be taken over by it. That measure improves the flow of forces and local stresses are reduced without that entailing a functional change or impairment in the crankshaft.

FIG. 6 shows a diagrammatic arrangement of the hardness points. In this case the extent d is the greatest transverse dimension of a preferably convex portion (‘hardness point’). The spacing s is the spacing of a given hardness point relative to the most closely adjacent hardness point.

It is then further pointed out that a region 4, 4′ to be hardened is desirably arranged at each rounded-off transition 3, 3′ of the crankshaft.

The invention is not limited to the described embodiments. For example it is possible to use in addition other hardening processes such as rolling, hammering and/or shot blasting. It will be appreciated that it is also possible to harden workpieces other than crankshafts.

1. A workpiece, in particular a crankshaft, the surface of which in a region to be hardened has a plurality of mutually spaced, hardened portions, characterised in that the extent (d) of the portions varies over the region to be hardened.

2. A workpiece as set forth in claim 1 characterised in that the spacing (s) of the hardened portions varies over the region to be hardened.

3. A workpiece as set forth in claim 1 characterised in that the portions are laser-hardened.

4. A workpiece as set forth in claim 1 characterised in that the portions are substantially punctiform portions.

5. A workpiece as set forth in claim 1 characterised in that the density (d/s) defined as the ratio of the extent (d) of a hardened portion to the spacing (s) of the most closely adjacent portion, for at least a part of the region to be hardened is between 0.1 and 5.0.

6. A workpiece as set forth in claim 1 characterised in that the density (d/s) defined as the ratio of the extent (d) of a hardened portion to the spacing (s) of the most closely adjacent portion for substantially all hardened portion is between 0.1 and 5.0.

7. A workpiece as set forth in claim 1 characterised in that the density (d/s) defined as the ratio of the extent (d) of a hardened portion to the spacing (s) of the most closely adjacent portion, for at least a part of the region to be hardened decreases towards the edge of the region to be hardened.

8. A workpiece as set forth in claim 1 characterised in that the density (d/s) defined as the ratio of the extent (d) of a hardened portion to the spacing (s) of the most closely adjacent portion for substantially all hardened portions decreases towards the edge of the region to be hardened.

9. A workpiece as set forth in claim 1 characterised in that the extent (d) of the hardened portions decreases towards the edge.

10. A workpiece as set forth in claim 1 characterised in that the extent of the hardened portions is between 0.1 mm and 5 mm.

11. A workpiece as set forth in claim 1 characterised in that the extent of the hardened portions is between 0.5 mm and 2.0 mm.

12. A workpiece as set forth in claim 1 characterised in that in a flat development the edge of the region to be hardened is of a substantially polygonal configuration.

13. A workpiece as set forth in claim 1 characterised in that in a flat development the edge of the region to be hardened is of a substantially elliptical configuration.

14. A crankshaft comprising at least one pin and at least one side cheek and a rounded-off transitional region between the pin and the side cheek, as set forth in claim 1, characterised in that the hardened portions are arranged at least partially in the rounded-off transitional region.

15. A crankshaft as set forth in claim 14 characterised in that the hardened portions are arranged substantially exclusively in the rounded-off transitional region.

16. A crankshaft as set forth in claim 14 characterised in that the density (d/s) defined as the ratio of the extent (d) of a hardened portion to the spacing (s) of the most closely adjacent portion, for at least a part of the region to be hardened, in the centre of the region to be hardened, is between 1 and 7 and continuously decreases outwardly to a value of 0.05 to 3.

17. A crankshaft as set forth in claim 14 characterised in that the density (d/s) defined as the ratio of the extent (d) of a hardened portion to the spacing (s) of the most closely adjacent portion, for at least a part of the region to be hardened, in the centre of the region to be hardened is being 5.0 and continuously decreases outwardly to a value of 0.1.

18. A crankshaft as set forth in claim 14 characterised in that the density (d/s) defined as the ratio of the extent (d) of a hardened portion to the spacing (s) of the most closely adjacent portion for substantially all hardened portions, in the centre of the region to be hardened is between 1 and 7 and continuously decreases outwardly to a value of 0.05 to 3.

19. A crankshaft as set forth in claim 14 characterised in that the density (d/s) defined as the ratio of the extent (d) of a hardened portion to the spacing (s) of the most closely adjacent portion for substantially all hardened portions, in the centre of the region to be hardened is being 5.0 and continuously decreases outwardly to a value of 0.1.

20. A crankshaft as set forth in claim 14 characterised in that hardening is effected only within an angle sector α facing towards the side cheek.

21. A crankshaft as set forth in claim 20 characterised in that the angle sector α is in a range of between 30° and 150°.

22. A crankshaft as set forth in claim 20 characterised in that the angle sector α is in the range of between 60° and 120°.

23. A crankshaft as set forth in claim 20 characterised in that the angle sector α is symmetrical with respect to the axis of the side cheek.

24. A crankshaft as set forth in claim 14 characterised in that a load-relief notch is arranged partially in the region of the rounded-off transition and partially in the crank pin.

25. A crankshaft as set forth in claim 14 characterised in that a load-relief notch is arranged partially in the region of the rounded-off transition and partially in the shaft journal.

26. A crankshaft as set forth in claim 14 characterised in that the base material comprises a hardenable steel.
